(19) United States
(12) Patent Application Publication
(10) Pub. No.: US 2016/0236745 A1
(43) Pub. Date: Aug. 18, 2016

(54) BICYCLE FRAME HAVING A TRI-OVAL FRAME MEMBER

(71) Applicant: Alter Cycles, Ltd., Grandville, MI (US)

(72) Inventor: Mark L. Groendal, Grandville, MI (US)

(21) Appl. No.: 15/047,602

(22) Filed: Feb. 18, 2016

Related U.S. Application Data
(60) Provisional application No. 62/117,736, filed on Feb. 18, 2015.

(51) Int. Cl. B62K 19/02

(52) U.S. Cl. CPC B62K 19/02

(57) ABSTRACT

A tube for use in a bicycle frame in which the tube has a first end and a second end, and a middle section extending between the ends. The first end, second end, and middle sections each have oval-shaped planar cross-sections. In the cross-sections of the first and second ends, the height is greater than the width. In the cross-section of the middle section, the width is greater than the height. This arrangement allows the middle section of the tube to flex vertically between it is narrower in the vertical direction. Likewise, this arrangement provides a strong connection point at the first and second ends which resists flex and movement vertically because the tube is thicker in the vertical direction.

### CROSS REFERENCE TO RELATED APPLICATION

This application claims the benefit of U.S. Provisional Application 62/117,736, which was filed on Feb. 18, 2015, the disclosure of which is hereby incorporated by reference.

### BACKGROUND OF THE INVENTION

1. Field of the Invention

The present invention pertains to a tube for use in a bicycle frame. More particularly, the present invention pertains to a tube for use in a bicycle frame having a cross-sectional shape that is variable along the length of the tube.

2. Description of the Prior Art

Bicycle frames have traditionally been designed to be as rigid and stiff as possible. The common belief was that any flex in the frame led to a loss of energy or weakness in the frame.

However, it has been determined by the inventor that this premise is not entirely true. Even more so, it has been determined that a bicycle frame that is specifically designed to have a degree of flex can function like a spring which stores and releases potential energy through each revolution of the pedals.

A bicycle frame having a flexible, removable down tube was previously disclosed in the Applicant's U.S. Pat. No. 8,991,848, the entire disclosure of which is hereby incorporated by reference. As discussed in that patent, there are several advantages to a bicycle having a flexible down tube that can be removed and replaced with a down tube having different characteristics. The increased vertical flexibility in the frame provided by the flexible down tube can increase the comfort for the rider by increasing the shock absorbency of the frame, and may also actually increase efficiency by reducing energy loss during pedaling. These benefits are achieved or enhanced by having a flexible top tube as well.

One potential problem with a flexible top tube, or with flexible frames in general, is that the flexing of the frame can increase stress on the joints between the tubes. This increased flex means more stress at the joints than is found in traditional bicycles with stiffer frames. This stress can be detrimental over time and can cause joints, particularly those that are welded together, to become weak or even to fail from fatigue.

Traditional frames often employ tubes that have consistent cross-sections through the entire length of the tubes. Often these cross-sections are circular. This is not ideal in frames where there is an attempt to increase the amount of flex in the tube. In these frames, a tube with a cross-section that has a lesser maximum vertical axis (referred to hereafter as “height”) than maximum horizontal axis (referred to hereafter as “width”) may be more flexible than its counterpart with a circular cross-section. For example, a top tube having oval-shaped cross-sections with a greater width than height (e.g., where the major axis is horizontal) will tend to allow more vertical flex than. a similar top tube with a circular cross-section.

As a frame becomes more flexible, however, this structure can become less than optimal. In the top tube of the previous example, for instance, the increased vertical flex may be found throughout the entire length of the tube. This means that there will be increased stress at the joints, namely, the first end point and second end point of the tube where the top tube is joined to the head tube and to the seat tube, respectively. That is to say, the result of the increased vertical flex in the top tube as a whole is an increase in flex at the potentially weak joints where the ends of op tube are attached to other parts of the frame.

Thus, there remains a need for a bicycle frame with an improved tube design that allows for increased vertical flex but decreases the stress on the joints between the top tube and other parts of the frame.

### SUMMARY OF THE INVENTION

According to a first embodiment of the present invention, there is provided a tube for use in a bicycle frame extending along a length l from a first end to a second end, the tube comprising:

the first end having a first planar cross-section, the first planar cross-section having a cross-sectional area a₁, a maximum height h₁, and a maximum width w₁;

the second end having a second planar cross-section, the second planar cross-section having a cross-sectional area a₂, a maximum height h₂, and a maximum width w₂; and

a middle section located along the length l of the tube between the first end and the second end, the middle section having a middle cross-section, the middle cross-section having a cross-sectional area aₘ, a maximum height hₘ, and a maximum width wₘ; wherein h₁>hₘ and h₂>hₘ, and w₁<wₘ and w₂<wₘ.

Although the cross-sectional areas a₁, a₂, and aₘ may be any suitable type of shape, preferably the cross-sectional areas a₁, a₂, and aₘ are oval or elliptical in shape.

Preferably, the maximum width along the length of the entire tube is wₘ, and the maximum height along the length of the entire tube is preferably h₁ or h₂. The height h₁ may also be equal to h₂, although not necessarily.

In addition, any of the three areas a₁, a₂, and aₘ may be equal in size to each other, although not necessarily.

Furthermore, the tube is preferably a top tube or a down tube, although it is possible that any other tube on the bicycle frame can utilize the tri-oval construction described herein. In addition, the tube can form any suitable shape in which the tube may be straight, arcuate, or the like.

According to a second embodiment of the present invention, there is provided a bicycle frame comprising:

a top tube, the top tube having a first end and a second end, the tube extending along a length l from the first end to the second end, and further having a middle point located along the top tube between the first end and the second end;

a seat tube connected to the second end;

a head tube connected to the first end;

a down tube connected to the seat tube at a point on the seat tube below the second end of the top tube, and the down tube connected to the head tube at a point on the head tube below the first end of the top tube;

the first end of the top tube having an oval-shaped first cross-section along a plane that is perpendicular to the length l of the top tube, wherein the first cross-section is greater in height than width;

the second end of the top tube having an oval-shaped second cross-section along a plane that is perpendicular to the length l of the top tube, wherein the second cross-section is greater in height than width; and

the middle point having an oval-shaped third cross section along a plane that is perpendicular to the length l of the top tube, wherein the third cross-section is greater in width than height.

Optionally, the top tube can include a second middle point located between the first end and the middle point, and a third middle point located between the second middle point and the middle point. The top tube decreases gradually in height and increases gradually in width between the second middle point and the third middle point.

Optionally, the top tube can also include a fourth middle point located between the second end and the middle point, and a fifth middle point located between the fourth middle point and the middle point. The top tube decreases gradually in height and increases gradually in width between the fourth middle point and the fifth middle point.

Preferably, the down tube is flexible and has an arcuate shape.

Furthermore, the height and width of the top tube is preferably substantially constant between the first end and the second middle point, and the height and width of the top tube is preferably substantially constant between the second end and the fourth middle point.

In addition, the height and width of the top tube is preferably substantially constant between the third middle point and the fifth middle point.

According to a third embodiment of the present invention, there is provided a bicycle frame comprising a top tube and a down tube in which the top tube and the down tube each have a “tri-oval” construction in which the height is the oval's major axis along a cross-section of the respective tube at the opposed ends of the top tube and down tubes where the respective tubes connect to a head tube and a seat tube, and the width is the oval's major skis along a cross-section of the respective tube at a medial point of the top tube and down tube.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a side elevational view of a bicycle frame of an embodiment of the present invention having a tri-oval top tube and tri-oval down tube showing cross-sectional views in FIGS. 1a-1f of the frame at various locations along the frame members;

FIG. 2 is a top side view of a top tube;

FIG. 3 is a side view of a top tube, shown 90° from the view shown in FIG. 2;

FIG. 4 is a perspective side view of a bicycle frame having a tri-oval top tube and having a replaceable down tube; and

FIG. 5 is a perspective view of a bicycle frame having a tri-oval top tube that is arcuate in shape along the length thereof.

### DETAILED DESCRIPTION OF THE PREFERRED EMBODIMENT

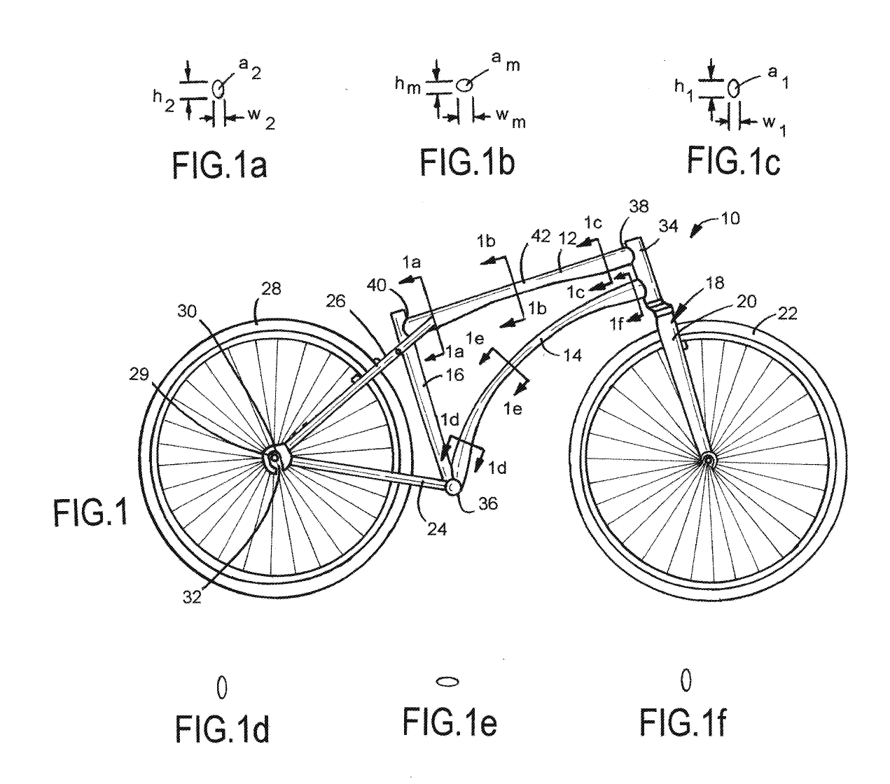

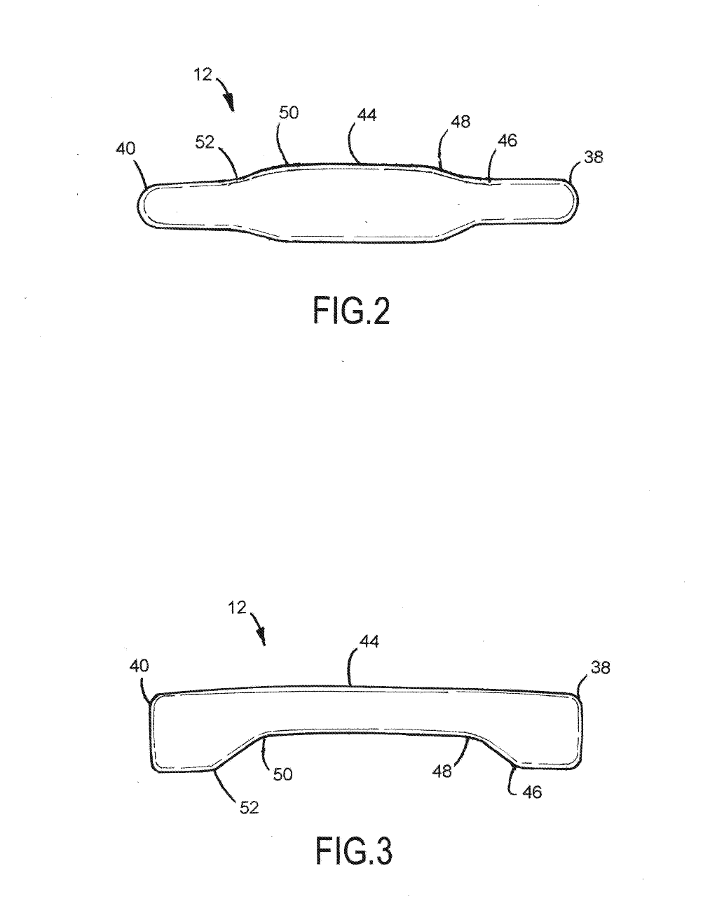

In accordance with the present invention and as shown generally in FIG. 1, a bicycle frame 10 constructed in accordance with the present invention comprises a top tube 12, a down tube 14, a seat tube 16, a head tube 34, and a front fork 18 comprising spaced forks 20 on opposite sides of a front wheel 22. Chain stays 24 and seat stays 26 are positioned on opposite sides of a rear wheel 28, with ends of the seat stays 26 and chain stays 24 being connected to a rear dropout 30 that engages an axle 29 on the rear wheel 28 and upwardly extending slot 32. A seat (not shown) is mounted on the upper end of a seat tube 16 in a conventional manner.

A handlebar assembly (not shown) is mounted on the upper end of head tube 34 at the front end of the frame 10. The bicycle is powered by a conventional pedal mechanism (not shown) attached to the bottom bracket shell 36 positioned at the bottom of the seat tube 16.

As referenced herein, the terms “height” and “width” are intended to generally refer to a vertical and horizontal orientation, respectively. However, more specifically the various cross-sections described herein are along a plane that is perpendicular to the length of the particular tube. In other words, the tube has an axis along the length thereof, and the plane of each cross-section is oriented 90° from the axis, such that the axis extends perpendicular from the plane. Thus, it is understood that the “height” and “width” of each cross-section is not necessarily vertical and horizontal, respectively. This is particularly true when the tube is arcuate and only a portion of the tube extends along a horizontal axis. The cross-sectional drawings of the tube from FIG. 1 and FIGS. 1a-1f should make apparent the orientation of each cross-sectional plane.

In the present invention, the bicycle frame 10 includes the top tube 12 that extends along a length l from a first end 38 to a second end 40. The top tube 12 has an oval cross-section near the first end 38 and second end 40 of the top tube 12 wherein the major axis is the height, and having an oval cross-section in the intermittent portion of the tube 12 wherein the major axis is the width.

As shown in FIGS. 1a-1c, the first end 38 has a first planar cross-section having a cross-sectional area a₁, a maximum height h₁, and a maximum width w₁. The second end 40 has a second planar cross-section having a cross-sectional area a₂, a maximum height h₂, and a maximum width w₂. There is also provided a middle section 42 located along the length l of the tube 12 between the first end 38 and the second end 40. The middle section 42 has a middle cross-section which has a cross-sectional area aₘ, a maximum height hₘ, and a maximum width wₘ. As described in greater detail below, the height and width dimensions of the first end 38, second end 40, and middle section 42 are such that h₁ and h₂ are both greater than hₘ, and wₘ is greater than both w₁ and w₂.

The cross-sectional areas a₁, a₂, and aₘ may be any suitable type of shape, however, preferably the cross-sectional areas a₁, a₂, and aₘ are oval or elliptical in shape.

Preferably, the maximum width along the length l of the entire tube is wₘ, and the maximum height along the length l of the entire tube is preferably h₁ or h₂. The height h₁ may also be equal to h₂, although not necessarily. In addition, any of the three areas a₁, a₂, and aₘ may be equal in size to each other, although not necessarily.

This structure allows for, and in fact encourages, more flex in the middle section 42 of the top tube 12 than at its ends. This flex in the middle section 42 of the top tube 12 tends to be in a vertical direction and can have an overall positive impact on the shock absorbing aspects and efficiency of the frame 10. The greater height of the cross-sections of the top tube 12 near the ends 38,40 of the tube 12 increases the resilience of the tube 12 at the ends 38,40 and restrains the tube 12 from flexing vertically as much at those ends. This is preferable in most instances because reducing flex at the ends helps to avoid undue stress on the connections between the top tube 12 and the seat tube 16, and between the top tube 12 and the head tube 34. This helps transfer stress away from the ends 38,40 of the tube 12.

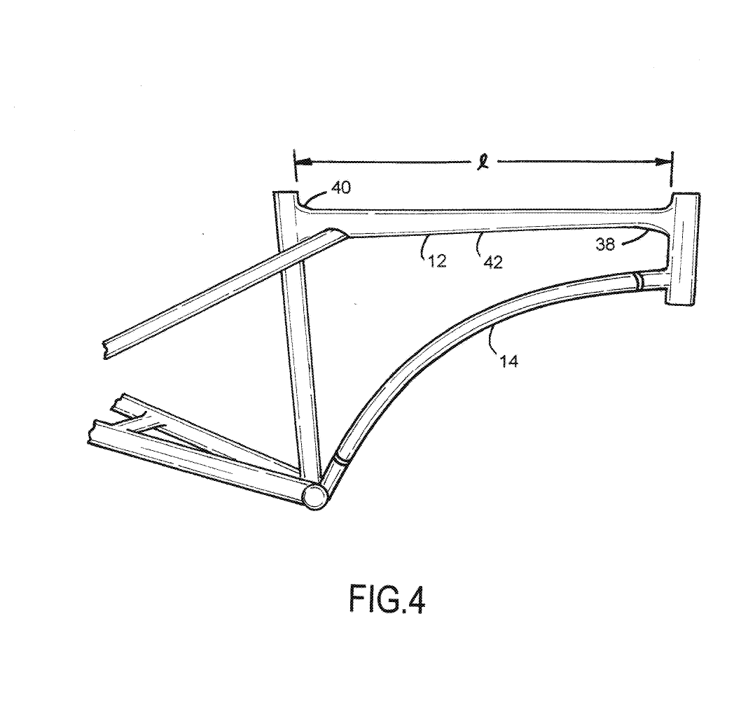

In one embodiment of the invention, shown in FIG. 4, the down tube 14 has an arcuate shape and is removably mounted to the frame 10 by connectors. The arcuate tube of this embodiment, however, does not employ a tri-oval tube design.

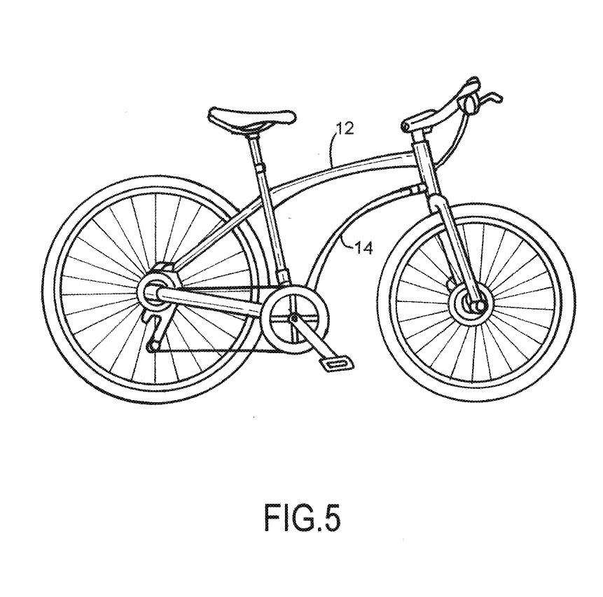

It is also contemplated that this type of tri-oval tube construction could also be used for tubes in the frame 10 other than the top tube 12. It may be particularly well-suited for a down tube 14, for example. This concept is employed in another embodiment of the invention, shown in FIG. 5, wherein the present invention is used for the down tube 14, and the down tube 14 has an arcuate shape similar to one or more of the down tubes 14 shown in U.S. Pat. No. 8,991,848, but differing in that it has the tri-oval geometry. In this embodiment of the invention, the down tube 14 is formed in an arcuate manner and is fastened securely to the frame 10 by welding or the like. In both the embodiment shown in FIG. 4 and the embodiment shown in FIG. 5, the down tubes 14 are flexible vertically.

It is contemplated that the tubes in the bicycle frame 10 can be connected to each other using any suitable connector that is well-known in the art. For example, this could include the connectors shown in U.S. Pat. No. 8,991,848, or even clips, preferably of the type shown in the Applicant's co-pending U.S. patent application Ser. No. 14/778,486, filed Sep. 18, 2015. Preferably, the top tube 12 is welded at one end to the head tube 34 and at the other end to the seat tube 16.

The top tube 12 has an oval-shaped cross-section at the first end 38, second end 40, and a middle point 44. According to one embodiment, the relative proportion of the major and minor axes of the oval-shaped cross-section at the first end 38 of the tube 12 is approximately 5:4. The cross-section of the tube 12 maintains this constant proportion from the first end 38 of the tube to a distance of about 10% of the total length of the tube, this location being defined as a second middle point 46. Approximately the next 22% of the length of the tube 12 has an oval-shaped cross-section that gradually decreases in height and increases in width, this location being defined as a third middle point 48. The decrease in height is caused by an upward slant in the bottom of the tube 12 while the top of the tube 12 maintains a consistent arcuate path. The increase in width is caused by a gradual outward bulging on both sides of the tube 12.

Continuing to move along the length of the tube 12 away from the head tube 34, approximately the next 41% of the length of the tube forms a middle portion, or middle section, which spans the middle point 44, and terminates at a location defined as a fifth middle point 50. In this middle portion, the cross-section of the tube 12 maintains a consistent proportion of about 5:3 between the major and minor axes, with the width of the tube 12 being the major axis.

Adjacent to the middle portion 42, and moving beyond the fifth middle point 50, the next approximate 13% of the length of the tube 12 has an oval-shaped cross-section that gradually increases back in height and decreases in width, this section terminating at a location defined as a fourth middle point 52. The increase in height is caused by a downward slant in the bottom of tube 12, while the top of the tube 12 maintains a consistent arcuate direction. The decrease in width is caused by a gradual inward draw on both sides of the tube 12. During the remaining approximate 14% of the length of the tube 12, the cross-section maintains a consistent proportion between the major axis (height) and the minor axis of about 5:4 until it terminates at the second end 40.

This top tube 12 has significant advantages. For example, by having a middle section 42 of the tube 12 that is less in height than width, there is a significant vertical flex in that portion of the tube 12. This is contrasted with the end portions (which are located between the first end 38 and the second middle point 46, and between the second end 40 and the fourth middle point 52), which have greater heights than widths, and which will tend to flex less in the vertical direction and thus place less stress on the welded joints.

In the preferred embodiment, there are oval-shaped cross-sections over the entire length of the tube 12, notwithstanding the two circular cross-sectional planes which may occur as the geometry of the tube 12 switches the major and minor axes between the height and the width. However, any other suitable shapes for the cross-sections are also contemplated, including ellipses, polygonal shapes, or even irregular shapes.

In addition, in the preferred embodiment, the top tube 12 is composed primarily of a flexible material, such as carbon fiber or titanium.

The foregoing describes applications of the present invention for a bicycle frame. Other features and applications of a similar nature are within the scope of the invention.

As is apparent from the preceding, the present invention provides a bicycle frame with an improved tube design that allows for increased vertical flex but decreases the stress on the joints between the top tube and other parts of the frame.

What is claimed is:

1. A tube for use in a bicycle frame, the tube extending along a length l from a first end to a second end, the tube comprising:
the first end having a first planar cross-section, the first planar cross-section having a cross-sectional area a₁, a maximum height h₁, and a maximum width w₁;
the second end having a second planar cross-section, the second planar cross-section having a cross-sectional area a₂, a maximum height h₂, and a maximum width w₂; and
a middle section located along the length l of the tube between the first end and the second end, the middle section having a middle cross-section, the middle cross-section having a cross-sectional area aₘ, a maximum height hₘ, and a maximum width wₘ;
wherein h₁>hₘ and h₂>hₘ, and w₁<wₘ and w₂<wₘ.

2. The tube of claim 1 wherein the cross-sectional areas a₁, a₂, and aₘ are each oval in shape.

3. The tube of claim 1 wherein the cross-sectional area a₁, a₂, and aₘ are each elliptical in shape.

4. The tube of claim 1 wherein the tube has a maximum width of wₘ.

5. The tube of claim 1 wherein the tube has a maximum height of h₁.

6. The tube of claim 1 wherein the tube has a maximum height of h₂.

7. The tube of claim 1 wherein h₁=h₂.

8. The tube of claim 1 wherein a₁=a₂.

9. The tube of claim 1 wherein a₁=aₘ.

10. The tube of claim 1 wherein a₂=aₘ.

11. The tube of claim 1 wherein the tuber is a top tube.

12. The tube of claim 1 wherein the tube is a down tube.

13. The tube of claim 1 wherein the tube is arcuate in shape along the length l.

14. A bicycle frame comprising:
a top tube, the top tube having a first end and a second end, the tube extending along a length l from the first end to the second end, and further having a middle point located along the top tube between the first end and the second end;
a seat tube connected to the second end;
a head tube connected to the first end;
a down tube connected to the seat tube at a point on the seat tube below the second end of the top tube and the down tube connected to the head tube at a point on the head tube below the first end of the top tube;
the first end of the top tube having an oval-shaped first cross-section along a plane that is perpendicular to the length l of the top tube, wherein the first cross-section is greater in height than width;
the second end of the top tube having an oval-shaped second cross-section along a plane that is perpendicular to the length l of the top tube, wherein the second cross-section is greater in height than width; and
the middle point having an oval-shaped third cross section along a plane that is perpendicular to the length l of the top tube, wherein the third cross-section is greater in width than height.

15. The bicycle frame of claim 14, wherein the top tube includes a second middle point located between the first end and the middle point, and a third middle point located between the second middle point and the middle point, and wherein the top tube decreases gradually in height and increases gradually in width between the second middle point and the third middle point.

16. The bicycle frame of claim 15, wherein the top tube includes a fourth middle point located between the second end and the middle point, and a fifth middle point located between the fourth middle point and the middle point, and wherein the top tube decreases gradually in height and increases gradually iii width between the fourth middle point and the fifth middle point.

17. The bicycle frame of claim 14 wherein the down tube is flexible and has an arcuate shape.

18. The bicycle frame of claim 16 wherein the height and width of the top tube remains substantially constant between the first end and the second middle point, and wherein the height and width of the top tube remains substantially constant between the second end and the fourth middle point.

19. The bicycle frame of claim 18 wherein the height and width of the top tube remains substantially constant between the third middle point and the fifth middle point.

20. A bicycle frame comprising a top tube and a down tube, the top tube and the down tube each having a “tri-oval” construction in which the height is the major oval axis along a cross-section of the respective tube at the opposed ends of the top tube and down tubes where the respective tubes connect to a head tube and a seat tube, and the width is the major oval axis along a cross-section of the respective tube at a medial point of the top tube and down tube.
